(19) United States
(12) Patent Application Publication
(10) Pub. No.: US 2024/0083393 A1
(43) Pub. Date: Mar. 14, 2024

(54) System and Method for Managing Water Usage Of a Car Wash System

(71) Applicant: QWash Management LLC, Euless, TX (US)

(72) Inventor: Viran Nana, Arlington, TX (US)

(21) Appl. No.: 18/112,292

(22) Filed: Feb. 21, 2023

Related U.S. Application Data
(60) Provisional application No. 63/405,091, filed on Sep. 9, 2022.

(51) Int. Cl. B60S 3/04; G07F 17/20

(52) U.S. Cl. CPC B60S 3/04; G07F 17/20

(57) ABSTRACT

A system and method for managing water usage of automated car wash equipment include a first data interface configured to automatically receive water usage data from a water meter coupled to a water line supplying water to the automated car wash equipment, a second data interface coupled to the processor and configured to automatically receive car wash data from the automated car wash equipment or a Point-of-Sale system, including date/time stamp of each car washed by the automated car wash equipment, type of wash for each car washed by the automated car wash equipment, and payment information for each car washed by the automated car wash equipment. The processor automatically processes and analyzes the water usage data and the POS data to generate at least one of: water usage per car washed by the automated car wash equipment, water usage trend data, water usage alerts, and water usage reports.

### RELATED APPLICATION

This application claims the benefit of U.S. Provisional Patent Application No. 63/405,091 filed on Sep. 9, 2022, the entirety of which is incorporated herein by reference.

### FIELD

The present disclosure relates to a system and method for managing water usage of an automated car wash system.

### BACKGROUND

One of the biggest expenses in operating a car wash business is the monthly water bill from the utility company. Due to water leaks and water recycling sub-system malfunctions, a car wash business often incurs unnecessary water waste. A car wash operator often is not informed of its water consumption until the arrival of the monthly water bill. Therefore, car wash owners and operators often cannot make timely corrective measures. This delay results in higher operating costs and loss of valuable resources.

### BRIEF DESCRIPTION OF THE DRAWINGS

A better understanding of the claimed subject matter can be obtained when the following detailed description of the disclosed embodiments is considered in conjunction with the following figures.

FIG. 1 is a simplified diagram illustrating an exemplary system and method for managing water usage by a car wash system according to the teachings of the present disclosure;

FIG. 2 is a simplified block diagram of an exemplary system and method for managing water usage of a car wash system according to the teachings of the present disclosure; and

FIG. 3 is a simplified flowchart illustrating an exemplary process of managing water usage by an automated car wash system according to the teachings of the present disclosure.

### DETAILED DESCRIPTION

Managing water consumption in a car wash business is often challenging due to unnecessary water waste because of inefficiencies in the water reclamation or recycling systems, valves inadvertently set at the wrong setting, leaks in the water lines, applicators not configured properly, or other defects. Car wash owners and operators often do not discover these problems until the water bill arrives the following month. Car wash owners and operators need a way to easily monitor water usage in real-time that helps them to timely identify water use and recycling issues so that they can address them quickly to curb waste and conserve water consumption.

A water usage manage system and method described herein provide car wash owners and operators easy and timely access to water usage and analysis information that enables them to anticipate the expenses associated with the business and take corrective actions if necessary. Through real-time monitoring and analysis, car wash owners and operators can designate different time periods of water usage, set up water usage alerts, identify excess consumption, and discover malfunctions in the system, such as leaks, improper configurations, and incorrect settings.

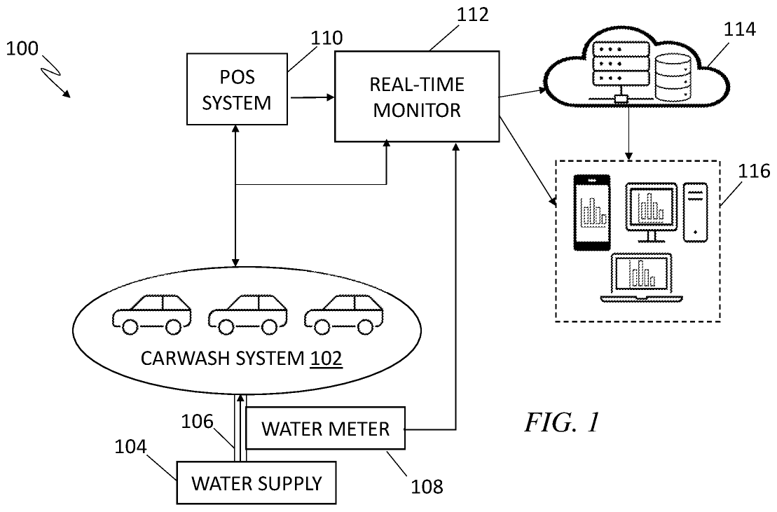

FIG. 1 is a simplified block diagram of an embodiment of a system and method 100 for real-time water consumption monitoring for an automated car wash system 102 according to the teachings of the present disclosure. An automated car wash system 102 employs spray jets, brushes, scrubbers, and other equipment to apply soap, remove dirt, and rinse vehicles moving sequentially down a track. The car wash equipment is connected to the city water supply 104, via a water line 106 to conduct the needed water to the premises. A water meter 108 is coupled to the water line 106 to keep track of water consumed by the car wash business. The car wash system 102 may include water recycling equipment that filters, cleans, and recirculates used water to reduce total water consumption.

An automated Point-of-Sale (POS) system 110 is coupled to the car wash system 102 that enables customers to purchase and pay for car washes, which may include multiple levels of service. The POS system 110 collects and stores data related to the car wash system 102, including the number of vehicles processed by the car wash system 103. The POS data may also include date/time stamps of each car washed, type of service, payment information, etc. The water meter 108 and the POS system 110 are coupled to a real-time monitor 112, which receives the water usage data and POS data related to water consumption by the car wash equipment. The data may be relayed via any suitable wired or wireless means.

In addition to the POS data, the car wash system 102 itself may generate and keep track of operating data such as the number of vehicles processed and the type of wash for each vehicle, and this car wash data is made available to the real-time monitor 112. The term “car wash” data is herein used to refer to the POS data from the POS system, car wash data generated by the car wash equipment, and/or a combination of data from both the POS system and the car wash equipment.

In particular, the car wash system 102 may include one or more optical sensors, proximity sensors, presence sensors, tape switch sensors, and any suitable sensors that are able to detect and generate a count for the number of vehicles washed and processed by the system 102. This vehicle count number is then used to analyze actionable key performance data relating to the operations of the car wash business.

The real-time monitor 112 is also in communications with one or more cloud-hosted servers and databases 114. The cloud-based servers and databases 114 may host a web-based portal configured to provide an interactive graphical user interface that enables the car wash owner or operator to easily access and view the car wash water consumption data and reports on a real-time basis using any type of computing device 116, including mobile phone, tablet computer, notebook computers, laptop computers, and desktop computers, wearable device, router, appliance, or other computing devices. The user may also set data parameters and user preferences using any one of the computing devices 116. Alternatively or additionally, the users may access and view data related to the car wash system 102 directly from memory onboard or associated with the real-time monitor 112.

The real-time monitor 112 is configured to process and analyze the data based on different parameters set up by the user. For example, the parameters may include date/time stamps, type of wash, payment information, etc. The real-time monitor 112 may analyze the data and provide insights related to the operations of the car wash system 102. For example, the real-time monitor 112 may determine the average quantity of water used to wash a vehicle, the average quantity of water used to wash a vehicle for each type of wash level, the average quantity of water used during specific time periods (e.g., hour, day, night, week, month), and water usage patterns or trends. The user may access raw water usage data and data analysis via the web portal and/or a graphical user interface directly supported by or integrated with the real-time monitor 112. The data may be presented in a number of formats such as charts, tables, graphs, and reports. The real-time monitor 112 may further generate alerts that are displayed or otherwise presented to the user (e.g., a text message or email) on a computing device if water usage is atypical or out of range, such as when water consumption per car is trending higher or is consistently above a certain threshold. The real-time monitor 112 may further detect when there are other anomalies associated with water usage. For example, the real-time monitor 112 may detect and alert that water usage for car wash level 3 has been consistently higher whereas there has been no change with other car wash levels. This may indicate, for example, leakage in certain water lines or defects in certain spray heads associated only with car wash level 3.

By having the real-time data at their disposal available in any number of formats, a user may easily discover defects, leaks, and malfunctions in the car wash system 102. For example, a user may set several time intervals, 2 h, 4 h, 6 h, and 8 h. The real-time monitor 112 compares the water consumption and the number of cars washed at different times, creating a report regarding the average water consumed per car in the 2 h interval. If a water leak happens, it may show on the report as an abnormal increase in water usage. With this report, a user may discover possible issues in the vehicle wash system.

A user may also use different water usage reports to determine what types of car wash program or vehicle costs more water. Optionally, a user may set a water consumption alert. When the quantity of water used exceeds the threshold, the user will receive a notification. Notifications may be automatically sent to a user based on their communication preference setting, such as email, voice mail, or text message.

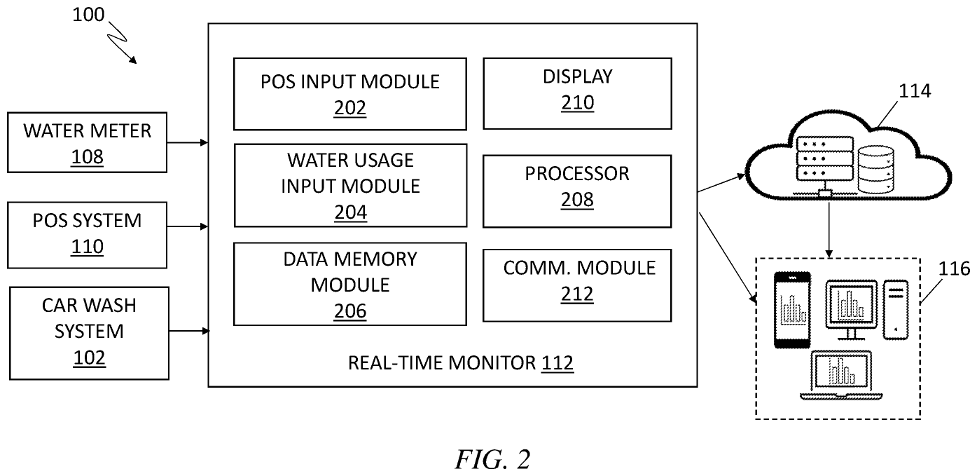

FIG. 2 is a more detailed block diagram of an exemplary system and method 100 for real-time water consumption monitoring for an automated car wash system 102 according to the teachings of the present disclosure. The real-time monitor 112 is operable to receive, transmit, store, process, display, and analyze data associated with water usage by the car wash system 102. The real-time monitor 112 may include a data interface (e.g., input modules 202 and 204) that receives point-of-sale data from the POS system 110, water usage data from the water meter 108, and/or car wash data from the car wash system 102. The data interface may receive data via any suitable wired or wireless means now known and later to be developed. The real-time monitor 112 further includes a data memory module 206 that is configured to store the received water usage data and car wash data. The real-time monitor 112 further includes a processor 208 that is configured to analyze data, detects actionable anomalies and conditions, and generates alerts. The real-time monitor 112 may optionally include a display 210 that enables a user to communicate with the processor and view data. Additionally, the real-time monitor 112 further includes a communication module 212 that enables the real-time monitor 112 to receive and transmit data to the remote cloud-hosted server and database 114 and/or with user devices 116. In one embodiment, the communication module 212 may support wired and/or wireless communication via any suitable network using any suitable communication protocol now known or later developed, including but limited to WiFi, LAN, WAN, Cellular, and Internet.

As described above, the processor 208 is configured to process water consumption and POS data stored in the data memory module 206 and analyze the data to provide real-time and trending information to the user, as well as having the capability to detect leaks and inefficiencies in the car wash system 102. The display module 210 is configured to provide an interactive interface and a graphical visualization of the water consumption data that may be characterized by date/time stamps, type of wash, payment information, etc., including the total water usage, the number of vehicles washed, or the average water usage per vehicle over a designated period. The display module 210 may also provide visual and/or audible alerts that flag issues that demand user attention.

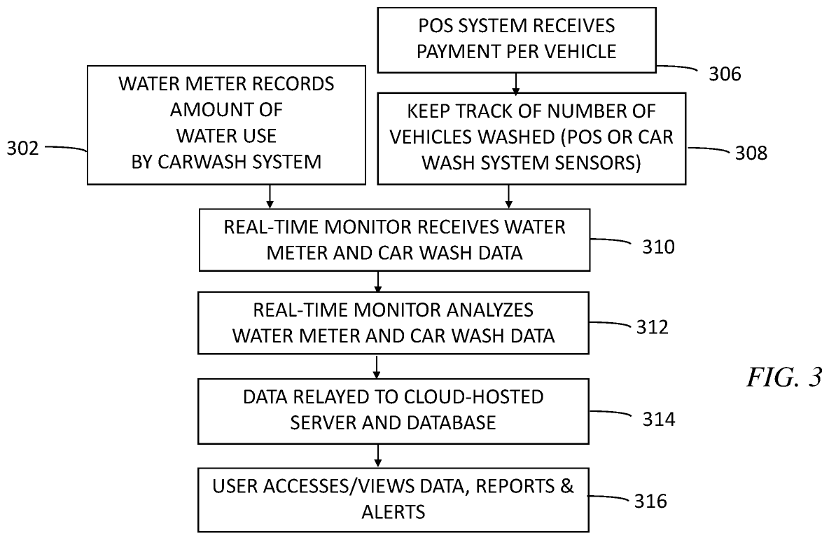

FIG. 3 is a simplified flowchart of an exemplary method for real-time water consumption monitoring for an automated car wash system according to the teachings of the present disclosure. In block 302, the water meter 108 keeps track of the amount of water used by the car wash system 102. At the same time, the POS system 110 receives user input for car washes, the type of wash, and receives payment, as shown in block 306. The POS keeps track of the number of vehicles washed, the type/level of wash, as well as timestamps for the processing of each vehicle, as shown in block 308. The water usage data and the car wash data are provided to and are received by the real-time monitor 112, as shown in block 310. The real-time monitor 112 may automatically receive or poll for the data on a real-time basis from the water meter 108, POS system 110, and/or car wash system 102. Alternatively, the real-time monitor 112 may automatically receive or poll for water usage data and/or car wash data on a periodic basis, such as hourly, every N hours, daily, weekly, bi-weekly, or monthly. The time period setting may be predetermined by the system or may be set by the user using a computing device 116 and/or via the web portal.

The real-time monitor 112 is configured to automatically use the water usage data and car wash data to determine one or more car wash operating parameters, as shown in block 312. For example, the real-time monitor 112 may determine the average amount of water used for each vehicle at multiple car wash levels. The real-time monitor 112 may compare the average water usage per vehicle on consecutive days to detect anomalies. For example, if the average water usage per vehicle on consecutive days differs by an amount that exceeds a predetermined threshold, then an alert may be generated and sent to the user. The real-time monitor 112 may analyze the water consumed over a predetermined period of time, the water usage related to each vehicle, the average water consumption per vehicle, the water usage efficiency connected with different operations or car wash programs, and/or the water expenses associated with different types or models of vehicles. The water usage and car wash data and analysis results are transmitted to the remote server and database 114, as shown in block 314. The user may access and view the data, reports, and alerts stored in the remote database 114 via the web portal and/or directly by accessing the real-time monitor 112, as shown in block 316.

In one embodiment, the water usage data can be displayed or accessed through a web page or a mobile app, containing water usage information based on data provided by the real-time monitor 112. The user may interact with the water usage information to monitor consumption, set alerts for consumption, and characterize water usage data based on vehicle types, numbers of vehicles washed, or predetermined time intervals. The display module may provide water usage information visually over predetermined time periods, such as 2 h, 4 h, 6 h, or the end of a business day, and generate water usage reports regarding the average water usage per vehicle at different times, the water consumption of different types of vehicles or vehicle wash programs, or the overall water usage trend. A user may use the water usage data, alerts, and reports to identify potential defects in the applicators, detect leaks, track water consumption, control water usage, and better manage water expenses in the car wash business.

The system preferably uses a mobile app executing on a mobile device to receive real-time water usage data from the water meter processor, owners and operators can view water usage reports whenever and wherever they want. This intelligence leads to timely notification and seamless adjustments to the car wash system based on real-time data. Such devices help owners and operators manage water expenses in a car wash business and avoid unnecessary water waste. It should be understood that the mobile app or software residing in the cloud server may receive water usage and car wash data directly from the water meter, POS system and/or car wash system, perform analysis, and generate water consumption data and reports that are insightful and informative to the user. In other words, a mobile app or software resident in the cloud server may take the place of the real-time monitor 112 and provide its functionalities.

Those skilled in the art will appreciate that the system and method described herein can be easily scalable to manage more than one car wash system/equipment at one location.

It should be noted herein that the term “car” is used to denote any type of mobile transportation vehicle that may travel on any type of terrain, in the air, on water, on rails, or any surface configuration. The term “car” is also used to denote any vehicle that can transport people, animals, or things.

The features of the present disclosure which are believed to be novel are set forth below with particularity in the appended claims. However, modification, variations, and changes to the exemplary embodiments described above will be apparent to those skilled in the art, and the disclosure described herein thus encompasses such modification, variations, and changes and are not limited to the specific embodiments described herein.

What is claimed is:

1. A system for managing water usage of automated car wash equipment, comprising:
a processor;
a first data interface coupled to the processor and configured to automatically receive water usage data from a water meter coupled to a water line supplying water to the automated car wash equipment, the water usage data indicative of water flow in the water line;
a second data interface coupled to the processor and configured to automatically receive car wash data from at least one of the automated car wash equipment and a Point-of-Sale (POS) system associated with the automated car wash equipment, the car wash data being selected from the group consisting of date/time stamp of each car washed by the automated car wash equipment, type of wash for each car washed by the automated car wash equipment, and payment information for each car washed by the automated car wash equipment;
a memory module coupled to the processor configured to automatically store the water usage data and the car wash data; and
wherein the processor is configured to automatically process and analyze the water usage data and the car wash data to generate at least one of: water usage per car washed by the automated car wash equipment, water usage trend data, water usage alerts, and water usage reports.

2. The system of claim 1, further comprising a communication module coupled to the processor and configured to automatically transmit the water usage data, the car wash data, and the water usage per car washed data to a remote server and database.

3. The system of claim 1, further comprising:
a communication module coupled to the processor and configured to automatically transmit at least one of water usage data, car wash data, water usage per car washed by the automated car wash equipment, water usage trend data, water usage alerts, and water usage reports to a remote server and database; and
a web portal hosted on the remote server and configured to automatically enable authorized users to view and access at least one of water usage data, car wash data, water usage per car washed by the automated car wash equipment, water usage trend data, water usage alerts, and water usage reports stored in the remote database.

4. The system of claim 3, further comprising a mobile app configured for executing on a user device and for enabling an authorized user to view and access at least one of water usage data, car wash data, water usage per car washed by the automated car wash equipment, water usage trend data, water usage alerts, and water usage reports stored in the remote database.

5. The system of claim 1, further comprising a mobile app configured for executing on a user device and for enabling an authorized user to view and access at least one of water usage data, car wash data, water usage per car washed by the automated car wash equipment, water usage trend data, water usage alerts, and water usage reports stored in the memory module.

6. The system of claim 1, further comprising a mobile app configured for executing on a user device and for enabling an authorized user to view and access at least one of water usage data, car wash data, water usage per car washed by the automated car wash equipment, water usage trend data, water usage alerts, and water usage reports stored in the remote database.

7. The system of claim 1, further comprising a user interface configured for enabling an authorized user to view and access at least one of water usage data, car wash data, water usage per car washed by the automated car wash equipment, water usage trend data, water usage alerts, and water usage reports on a real-time basis.

8. The system of claim 1, further comprising a mobile app configured for executing on a user device and for enabling an authorized user to view and access at least one of water usage data, car wash data, water usage per car washed by the automated car wash equipment, water usage trend data, water usage alerts, and water usage reports stored in the memory module on a real-time basis.

9. A method of managing water usage of automated car wash equipment, comprising:
automatically receiving real-time water usage data from a water meter coupled to a water line supplying water to the automated car wash equipment, the water usage data indicative of water flow in the water line;
automatically receiving car wash data from at least one of the automated car wash equipment and a Point-of-Sale (POS) system associated with the automated car wash equipment, the car wash data being selected from the group consisting of date/time stamp of each car washed by the automated car wash equipment, type of wash for each car washed by the automated car wash equipment, and payment information for each car washed by the automated car wash equipment;
automatically analyzing the water usage data and the car wash data to generate at least one of: water usage per car washed by the automated car wash equipment, water usage trend data, water usage alerts, and water usage reports; and
enabling access and viewing by an authorized user of the at least one of water usage per car washed by the automated car wash equipment, water usage trend data, water usage alerts, and water usage reports.

10. The method of claim 9, further comprising automatically transmitting the water usage data, the POS data, and the water usage per car washed data to a remote server and database.

11. The method of claim 9, further comprising:
transmitting at least one of water usage data, car wash data, water usage per car washed by the automated car wash equipment, water usage trend data, water usage alerts, and water usage reports to a remote server and database; and
providing a web portal hosted on the remote server and configured to enable authorized users to view and access at least one of water usage data, car wash data, water usage per car washed by the automated car wash equipment, water usage trend data, water usage alerts, and water usage reports stored in the remote database.

12. The method of claim 11, further comprising enabling an authorized user to view and access, via a mobile app executing on a user device, at least one of water usage data, car wash data, water usage per car washed by the automated car wash equipment, water usage trend data, water usage alerts, and water usage reports stored in at least one of the remote database and the memory module.

13. The method of claim 9, further comprising enabling an authorized user to view and access, via a mobile app executing on a user device, at least one of water usage data, car wash data, water usage per car washed by the automated car wash equipment, water usage trend data, water usage alerts, and water usage reports stored in at least one of the remote database and the memory module.

14. The method of claim 9, further comprising enabling an authorized user to view and access, via a user interface enabled by the processor, at least one of water usage data, car wash data, water usage per car washed by the automated car wash equipment, water usage trend data, water usage alerts, and water usage reports on a real-time basis.

15. The method of claim 9, further comprising enabling an authorized user to view and access, via a mobile app executing on a user device, at least one of water usage data, car wash data, water usage per car washed by the automated car wash equipment, water usage trend data, water usage alerts, and water usage reports stored in the memory module on a real-time basis.

16. The method of claim 9, wherein analyzing the water usage data and the car wash data comprises comparing current water usage data to historic water usage data to identify actionable conditions related to water usage by the automated car wash equipment.

17. A set of computer instructions for encoding on a tangible medium and executing a method of managing water usage of automated car wash equipment, the method comprising:
automatically receiving real-time water usage data from a water meter coupled to a water line supplying water to the automated car wash equipment, the water usage data indicative of water flow in the water line;
automatically receiving car wash data from at least one of the automated car wash equipment and a Point-of-Sale (POS) system associated with the automated car wash equipment, the car wash data being selected from the group consisting of date/time stamp of each car washed by the automated car wash equipment, type of wash for each car washed by the automated car wash equipment, and payment information for each car washed by the automated car wash equipment;
automatically analyzing the water usage data and the car wash data to generate at least one of: water usage per car washed by the automated car wash equipment, water usage trend data, water usage alerts, and water usage reports; and
enabling access and viewing by an authorized user of the at least one of water usage per car washed by the automated car wash equipment, water usage trend data, water usage alerts, and water usage reports.

18. The method of claim 17, further comprising:
transmitting at least one of water usage data, car wash data, water usage per car washed by the automated car wash equipment, water usage trend data, water usage alerts, and water usage reports to a remote server and database; and
providing a web portal hosted on the remote server and configured to enable authorized users to view and access at least one of water usage data, car wash data, water usage per car washed by the automated car wash equipment, water usage trend data, water usage alerts, and water usage reports stored in the remote database.

19. The method of claim 17, further comprising enabling an authorized user to view and access, via a mobile app executing on a user device, at least one of water usage data, car wash data, water usage per car washed by the automated car wash equipment, water usage trend data, water usage alerts, and water usage reports stored in at least one of the remote database and the memory module.

20. The method of claim 17, wherein analyzing the water usage data and the car wash data comprises comparing current water usage data to historic water usage data to identify actionable conditions related to water usage by the automated car wash equipment.
